(19) United States
(12) Patent Application Publication
(10) Pub. No.: US 2002/0131397 A1
(43) Pub. Date: Sep. 19, 2002

(54) Method and system for high speed wireless broadcast data transmission and reception

(76) Inventors: Rajendra Patel, Chevy Chase, MD (US); Jamshed Dadi Mulla, Potomac, MD (US)

Correspondence Address: SONNENSCHEIN NATH & ROSENTHAL, P.O. BOX 061080, WACKER DRIVE STATION, CHICAGO, IL, 60606-1080, US

(21) Appl. No.: 10/091,705

(22) Filed: Mar. 6, 2002

Related U.S. Application Data
(63) Continuation-in-part of application No. 09/947,980, filed on Sep. 6, 2001.
(60) Provisional application No. 60/230,710, filed on Sep. 7, 2000.

(51) Int. Cl. H04J 3/24

(52) U.S. Cl. 370/349; 370/389

(57) ABSTRACT

The invention may be broadly conceptualized as an approach in which a wireless device is able to receive broadcast data over a payload channel established in another network and establishing payload channels directly with the wireless device when high bandwidth data exchanges are need, and in times of emergency enabling barge-in functionality controlled by the management network.

### 1. REFERENCE TO EARLIER-FILED APPLICATION

This application is a Continuation-In-Part of patent application Ser. No. 09/947,980 filed Sep. 6, 2001, entitled “Method and System for High Speed Wireless Data Transmission and Reception”, which claimed the benefit of U.S. Provisional Application No. 60/230,710, entitled “Method and System for High Speed Wireless Data Transmission and Reception,” filed Sep. 7, 2000.

### BACKGROUND OF THE INVENTION

1. Technical Field

The invention relates to the management of wireless devices across multiple networks. More particularly, the invention relates to dynamic assignment of an identifier to a wireless device communicating with a wireless management network in addition to multiple voice and/or data networks while increasing the seamlessness, reliability, robustness and security of communication provided to the wireless device.

2. Related Art

Currently, wireless networks allow devices such as cellular phones, wireless modems and personal digital assistants (PDAs) to operate within a specific wireless network. Each device is dedicated to a predetermined network and has limited ability to roam into other networks. In cellular telephonic networks, roaming across networks has been accomplished by network-to-network communication for handing over the call from one network to another network. The wireless device being handed over has the ability to communicate with the new network in order to set up the voice or payload channel. Further, to facilitate the roaming of wireless devices from one network into another, a number of protocols between wireless networks have been devised, such as MOTOROLA's DMX protocol, IS-41 standard and IS-136 standard. A problem with the current approaches is that the wireless networks must be similar or the wireless devices must be multimode capable (i.e. Digital CDMA and Analog). In either case, the cellular service provider that the user of the device subscribes to determines the assign roaming network and service capabilities.

A number of wireless Internet services, such as stock quotes, games and messaging systems, are in development for access by wireless devices. Some cellular networks, such as a GSM network, have even attempted to implement “short message services” that enable relatively small amounts of data to be transmitted to a cellular device over a control channel. But, such implementations are adapted for short text messages rather than accessing the Internet and upon the cellular device switching between networks the service may or may not be provided. Thus, there is a needed in the art for wireless devices to be able to access data services seamlessly across a plurality of wireless networks at greater speeds than currently available.

Communication between the wireless network and a wireless device in current implementations occur over dedicated data channels. Bandwidth is dedicated to each user in fixed allocation units irrespective of the user's data throughput requirements or usage pattern. This results in inefficient use of precious spectral resources.

The conventional method of identifying users of a wireless network is by assigning each of the devices a fixed identification tag that is verified by the wireless network before the device is granted access to the wireless network. These identification tags are traditionally pre-assigned either by the device manufacturer, in the case of an equipment serial number, or by the network operator, in the case of a subscriber's identification number and telephone number. The equipment and subscriber identities are held in the device either by permanently encoding into a hardware component or by storage in a non-volatile memory inside the device. In some technologies such as GSM, part of the identities is stored in a removable module that can be physically removed from one device and inserted into another. Only the device that contains the module is able to operate with the embedded identities at any given time. While roaming, devices may be dynamically assigned temporary roaming identities, but the permanent identities are typically used for accounting purposes.

Furthermore, traditional networks are limited in their ability to broadcast messages to wireless devices. Often, a short text message is sent over a control channel to a wireless device. The wireless device is limited in its ability to receive messages while roaming outside its network and the wireless network is limited in how much information is sent across the control channel. Further, the ability of routing broadcast messages to wireless devices is often affected when network failures occur due to faults or disasters, such as earthquakes, terrorist acts, or hardware failures.

What is needed in the art is a method to communicate with wireless devices across wireless networks with an approach that provides increased data throughput and success of transmission in times of emergency.

### SUMMARY

A management network is provided that enables a wireless device to be configured to access a wireless network from a plurality of possible wireless networks. By using an access management channel of the management network, a wireless device is able to receive information associated with accessing another network and the utilization of bandwidth from the other networks is controlled by the management network based on the subscriber's service plan parameters, real-time usage pattern, availability of channels and commercial agreements between the management network operator and the payload network operators. The access management channel may also be configured to provide up to a predetermined amount of data in-band to and from the wireless device using a packet protocol, such as TCP/IP or other packet protocols as appropriate. Further, by using the management network to configure the wireless device, different payload networks may be accessed, such as a private data network (e.g. 802.11) during predetermined periods and a cellular network during other periods or when the wireless device is at another locations. The selection of a specific network technology, such as CDMA, TDMA, GSM, or data wireless network may be determined by the device capabilities or factors from commercial agreements between the management network and payload network operators.

The management network enhances the utilization of the payload networks and enables the assignment of multiple wireless devices to a fixed set of payload channels to optimize the overall efficiency of the allocated spectrum. Each wireless device is dynamically assigned a wireless device identifier. Data is encoded with the dynamic wireless device identifier and broadcast to a pilot device over a payload channel of a wireless network. The access management network instructs the wireless device via the access management channel to monitor the payload channel of the pilot device for data containing the dynamic wireless device identifier.

The management network also enables network diversity. The WAM network has the ability to engage all payload networks in the service area. By controlling the user device's access to multiple networks, the WAM system can select the most appropriate payload network based on availability and congestion during a disaster. A common type of localized disaster could involve damage to or loss of a cell site. Due to the high degree of collocation of base stations in the current wireless deployment environment, a loss of this type would likely affect multiple operators at the same location.

The loss of a single base station does not create a major coverage problem in the payload networks since most densely populated areas are currently dominated by capacity requirements rather than coverage. Hence, adjoining cells would automatically “expand” to absorb the coverage area of lost cells. However, there would be a greater impact on capacity in the immediate area since the traffic channels lost in this type of failure cannot be readily or entirely replaced by the adjacent cells.

In a disaster where carrier network cells sites are lost, the WAM-enabled user is automatically directed to surviving networks using network diversity. Network diversity also is beneficial when the emergency results in network overload by looking for an available channel on all networks instead of just one. Further, calls that currently have been established can be managed by an emergency management center and connections made by use of a barge-in call setup.

Network diversity also creates a significant enhancement in the security of data transmission in the WAM network compared to traditional wireless networks. When multiple payload channels from different networks are assigned to a single user device, the data packets transmitted from the WAM system to the device will be dispersed randomly across the payload channels in use, thus making it difficult to reconstruct the original transmission without knowledge of the payload networks and channels in use and the dispersal algorithm.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

The components in the figures are not necessarily to scale, emphasis instead being placed upon illustrating the principles of the invention. In the figures, like reference numerals designate corresponding parts throughout the different views.

FIG. 1 is a block diagram of a wireless access management system 100 in accordance with an embodiment of the invention.

FIG. 2 is a block diagram of WAM network 106 within the wireless access management system 100, of FIG. 1 in accordance with an embodiment of the invention.

FIG. 3 is a message flow diagram 300 of a wireless device 102 initiated a burst mode data transfer in WAM network 106 of FIG. 2 in accordance with an embodiment of the invention.

FIG. 4 is a message flow diagram 400 of an Internet host 312 initiated burst mode data transfer with wireless device 102 in a WAM network 106 of FIG. 2 in accordance with an embodiment of the invention.

FIG. 5 is a message flow diagram 500 of an AMC manager 204 initiated acquired bandwidth data transfer in WAM network 106 of FIG. 2 in accordance with an embodiment of the invention.

FIG. 6 is a flow diagram of the process of an AMC manager 204 dynamically allocating and de-allocating payload channels for a wireless device 102 in WAM network 106 of FIG. 2 in accordance with an embodiment of the invention.

FIG. 7 is a block diagram of the WAM network 706 incorporating the broadcast mode of operation in accordance with an embodiment of the invention.

FIG. 8 is a message flow diagram 800 of wireless devices 102 and 103 engaging in a broadcast mode operation within the WAM network 706 of FIG. 7 in accordance with an embodiment of the invention.

FIG. 9 shows a block diagram of the organization of universal and virtual (or “soft”) identities in a wireless device 102.

FIG. 10 is a message flow diagram 1000 of a voice call originating from the PSTN 114 and terminating at the wireless device 102 where the wireless device 102 is assigned a soft identity by the WAM network 706.

FIG. 11 is a message flow diagram 1100 of the wireless device 102 engaging in a soft identity transaction within the WAM network 706 of FIG. 7 in accordance with an embodiment of the invention.

FIG. 12 is a flow diagram of the process of wireless devices 102 and 103 engaging in a broadcast mode operation within the WAM network 706 of FIG. 7 in accordance with an embodiment of the invention.

FIG. 13 is a flow diagram of the process of a wireless device 102 engaging in a soft identity transaction within WAM network 706 of FIG. 7 in accordance with an embodiment of the invention.

FIG. 14 is a diagram of a WAM network with two wireless devices in communication prior to an emergency condition in accordance with an embodiment of the invention.

FIG. 15 is a diagram of the WAM network of FIG. 14 after the calls are switched to the Emergency Management Center in accordance with an embodiment of the invention.

FIG. 16 is a diagram of the WAM network of FIG. 14 with an incoming call from a priority caller to a busy wireless device in accordance with an embodiment of the invention.

FIG. 17 is a diagram of the WAM network of FIG. 14 with a Barge-in performed at the Emergency Management Center.

FIG. 18 is a flow diagram of the steps taken when an emergency occurs in the WAM network of FIG. 14.

### DETAILED DESCRIPTION OF THE EXEMPLARY EMBODIMENTS

Reference is now made in detail to an embodiment of the present invention, an example of which is illustrated in the accompanying drawings, showing a system and method for real-time steering of content (data) by an access control management network to or from a wireless device to one of a possible plurality of wireless networks. The data being transported is IP-based Internet data, such as web pages and may be exchanged at a wide range of speeds from several kilobits per second (“Kbps”) to over several megabits per second (“Mbps”) such as two Mbps that is envisioned in third-generation (3G) wireless networks. Further, the data may be in the form of packet data, packet voice data, or circuit voice. In alternate embodiments, other types of data may be transport to and from the wireless device, such as text data, encrypted data, packet data, or compressed data.

### Wireless Access Management Network

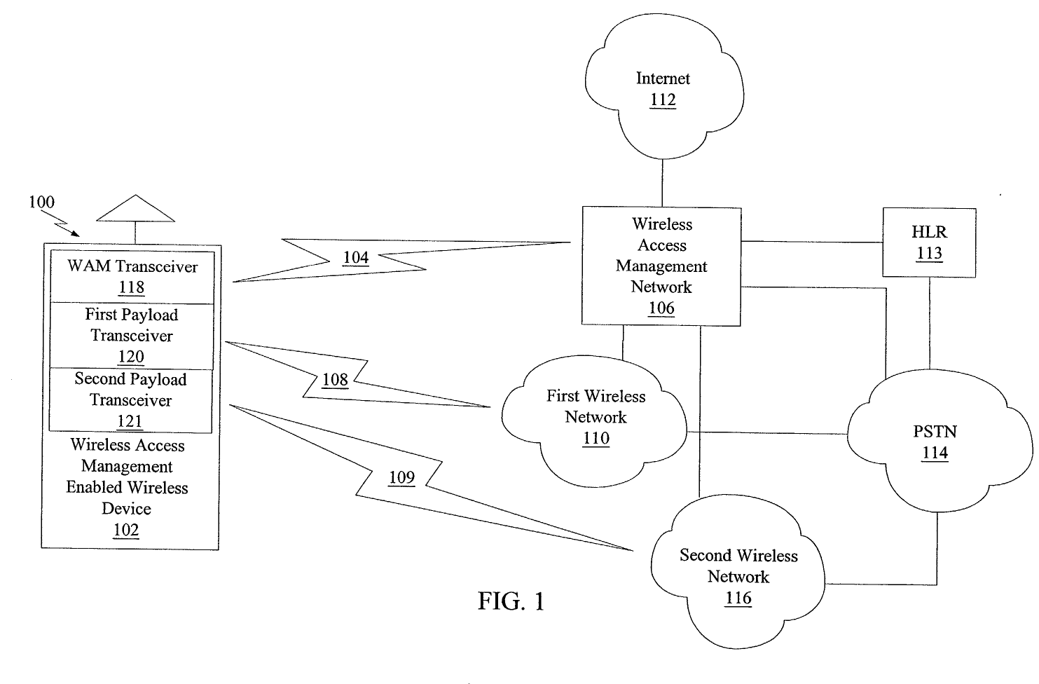

In FIG. 1, a block diagram of a wireless access management system 100 is shown. A wireless device 102 is in communication over an access management channel (AMC) 104 with a wireless access management (WAM) network 106 and over wireless payload channels 108 and 109 with the first wireless network 110 and the second wireless network 116 respectively. The WAM network 106 is connected to the Internet 112, a public switch telephone network (PSTN) 114 and may be directly connected to the first wireless network 110 and the second wireless network 116. The PSTN 114 is connected to the first wireless network 110 and a second wireless network 116. A WAM Home Location register (HLR) 113 is connected to the WAM network 106 and to the PSTN 114. The PSTN 114 may be implemented as a public switch network, a private network, a home-based network, a data network, or any combination of the previous types of networks in alternate embodiments of the invention.

The wireless device 102 is able to receive and transmit control information and data through a WAM transceiver 118 with the WAM network 106 over the AMC 104. Further, the wireless device is also able to exchange data and control information through a payload transceivers 120 and 121 over the payload channels 108 and 109 and corresponding control channels associated with the first wireless network 110 and the second wireless network 116. Examples of technologies used in the first wireless network 110 or second wireless network 116 include GSM/GPRS and CDMA 1×RTT. The payload transceiver 120 communicates over one or more separate control channels associated with the assigned network (the first wireless network 110 in the FIG. 1) in addition to transferring data over the assigned payload channel 108. In an alternate embodiment, a common tunable transceiver may be used. Examples of some wireless devices that may incorporate a WAM transceiver 118 include cellular telephones, Personal Digital Assistants (PDAs), computers having a wireless modem computer card (PCMCIA card, PCI card) that contains a WAM transceiver, and Internet appliances.

FIG. 1 shows a wireless device with only two payload transceivers, but in other embodiments it is possible for a greater number of transceivers to exist in a single wireless device with each transceiver communicating with a different wireless network or on a different payload channel of the same wireless network as another transceiver.

The wireless device 102 also contains a controller, such as a processor, digital signal processor, application specific integrated circuit (ASIC), discrete logic functioning as a state machine, analog circuit functioning as a state machine, software programs functioning with any of the previous types of hardware to act as a state machine, and a combination of the above. The controller is in communication with WAM transceiver 118, payload transceiver 120 and a data port interface. The data port interface is a data bus in the wireless device 102, such as a PCMCIA bus, PCI bus, serial data bus, parallel bus, SCSI bus, or even a network interface (802.3, token ring, etc.). The data port interface may pass data from computer memory (RAM, ROM, SDRAM, EEPROM etc.), disk drive (floppy, Compact Disk, hard disk drive, removable hard drive, DVD etc.), keyboards, mice, touch screens or other data storage or entry devices that can generate data for transmission over the AMC 104 of a WAM network 106 or a payload channel 108 over the first wireless network 110. The data port interface may also pass data from the AMC 104 or payload channel 108 to display devices such as monitors, LCD screens, printers, plotters, image capturing devices, etc. Further, the controller processes the data that is received at and transmitted from the wireless device 102. The controller also processes control messages received from the WAM network 106.

The WAM architecture utilizes a secured and clear bandwidth (with about 0.5 MHz of continuous bandwidth) for the AMC. A single RF channel pair makes up the AMC 104 and operates at a predetermined time within each WAM cell. The forward channel is operated as a broadcast channel. In the forward direction, all wireless devices are listening within the WAM cell to the forward AMC RF frequency and receive the base station transmissions. In the reverse direction, the base station part of the WAM network 106 receives the transmission of the wireless device 102 that is transmitting at a predetermined times on the reverse AMC RF frequency. The reverse channel is operated as a time-domain multiple access (TDMA) channel. When collisions occur the wireless device 102 senses the collision and backs off a random amount of time before trying to gain access again. Each wireless device 102 may access a time slot in the reverse channel for transmission of control information and data. In an alternate embodiment, a plurality of time channels may be combined to increase the amount of data being transmitted from the wireless device 102 to the WAM network 106.

Transactions between the wireless device 102 and the WAM network 106 are divided into two main categories: user-initiated sessions and network-initiated sessions. These two categories are further subdivided as shown in Table 1.

TABLE 1
Network Transaction Types

| User Initiated | | Network Initiated | |
|---|---|---|---|
| Browsing | Time Critical | Broadcast | Alert |
| Similar to | Flight check-in | Traffic report | Incoming e-mail |
| desk-top | Money transfer | Advertising/promo- | Update stock |
| web-brows- | Stock purchase | tions | quote |
| ing | | Location-specific | |
| | | news and information | |
| | | Auction participation | |

Command-and-control information relating to user-initiated browsing sessions and network-initiated broadcast sessions (i.e. session-initiation, session management and session termination) are transported across the AMC, whereas the actual content is normally transported across the payload channels 108 and 109, particularly during peak traffic periods. The other two sub-categories, i.e., user initiated time critical and network-initiated alert sessions, the control as well as the payload information is carried across the AMC 104. One of the aspects of this approach is to ensure that the content providers need not rewrite their software while at the same time the user's look and feel is no different than experienced during a desktop session using wired facilities.

According to another embodiment, the AMC 104 is an always-available wireless access channel, and it carries all control packets including payload steering messages as well as about 75% or more of the up-link (wireless device 102 to WAM network 106) messages. A selection of bandwidth in the frequency range of 220 MHz-2 Ghz for the AMC 104 means that the propagation characteristics of the AMC 104 is comparable to existing cellular/Personal Communication Services (PCS) networks. Alternatively, narrowband PCS spectrum in combination with paging channels may be used for the required bandwidth. When a wireless device 102 is switched on and in the idle state, only the command and control AMC channel 104 connects the device to the WAM network 106. Short, time-critical or other information meeting predetermined criteria (e.g. type of data, size of data, security level required, etc.) are transmitted over the AMC 104. The WAM network 106 constantly monitors the rate of data flowing to and from the wireless device 102. When the data flow between the wireless device 102 and WAM network 106 in either direction meets certain criteria, the WAM network determines if the allocation of a payload channel is permitted for the subject wireless device 102 and allocates an additional payload channel accordingly. Similarly, the WAM network determines when the criteria have been met to de-allocate a payload channel.

In another embodiment, a determination is made by the WAM network 106 to select a payload carrier and then another selection is made as to which wireless network 110 or 116 to set up the payload carrier through. The criteria for selection of the wireless network 110 or 116 may include time, bandwidth costs, device capability, subscriber preference, type of data, data security, and requesting application. In FIG. 1 only two networks are shown, but in other embodiments more than two wireless networks may be available to supply payload channels. The wireless networks may be any combination of public networks, private networks, and home based networks that may be accessed by wireless device 102.

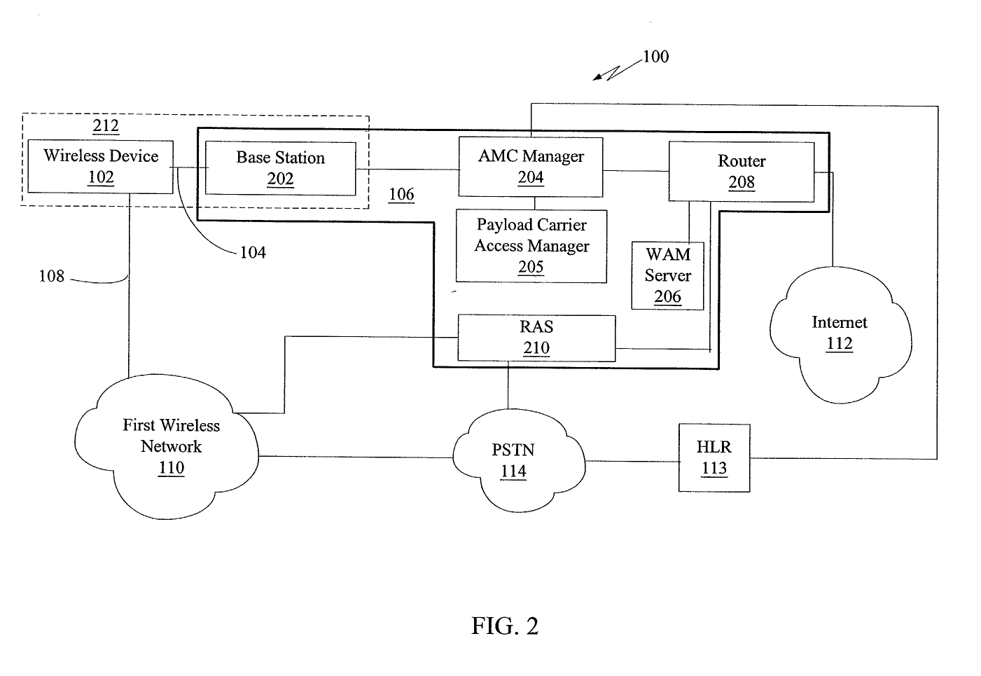

Turning to FIG. 2, a block diagram of WAM network 106 within the wireless access management system 100, of FIG. 1 is shown. The wireless device 102 communicates with WAM network 106 and first wireless network 110. The WAM network 106 has a base station 202 that contains a transceiver for communicating over the AMC 104. The base station 202 is controlled from ACM manager 204 (sometimes referred to as the WAM node) that is in communication with a payload carrier access manager 205 and a router 208. The router 208 is connected to the AMC manager 204, WAM server 206, the Remote Access Server (RAS) 210 and the Internet 112. The RAS 210 is connected to the router 208 and the first wireless network 110 and a data/voice network (PSTN 114). The first wireless network 110 may also be in communication with the wireless device 102 over payload channel 108.

The base station 202 is present in each cell of a WAM network 106 and performs data link or media access relay functions for the AMC 104 serving the WAM cell 212. In the forward direction, the base station 202 receives information from the AMC manager 204 and relays it over the AMC 104 to the wireless device 102. In the reverse direction, the base station 202 receives signals from the wireless device 102 within the WAM cell 212 over AMC 104 and relays them to the AMC manager 204. The wireless device 102 traveling from a WAM cell 102 to a neighboring WAM cell will result in a hand-over that is managed by the AMC manager 204 (similar to a cellular hand-over). In an alternate embodiment, a base station controller may control a number of base stations and handle the hand-overs that occur between base stations associated with that base station controller, while hand-over between base stations associated with different base station controllers will involve the AMC manager 204.

The AMC manager 204 performs base station management and can interface with a large number of base stations. The interface between the AMC manager 204 and base station 202 uses the IP protocol, but other protocols may be used in alternate embodiments. Typically a dedicated 64K DSO, DSL or ISP dedicated line will be used for transmission of the IP protocol. The AMC manager 204 also implements other layers of the protocol for the AMC 104 as appropriate. It multiplexes outbound messages for the wireless device 102 currently registered in each associated WAM cell, such as WAM cell 212. Further, the AMC manager 204 processes registration and packet messages and then forwards the messages on to the router 208. The AMC manager 204 uses a frame relay protocol to interface to router 208. In alternate embodiments, the AMC manager 204 may interface to multiple routers that interface with multiple RASs. In yet another alternate embodiment, a PPP protocol is used to interface the AMC manager 204 with router 208, or a combination of frame relay and PPP may be used to interface the AMC manager 204 with a plurality of routers.

The wireless AMC manager 204 also contains a controller, such as a processor, digital signal processor, ASIC, discrete logic functioning as a state machine, analog circuit functioning as a state machine, software programs combined with hardware functioning as a state machine, and a combination of the above that is coupled to a AMC interface that formats (TDMA, CDMA, CDMA2000, etc.) the control messages and data for transmission over the AMC 104. The controller processes the data that is received at and transmitted to the wireless device 102. The control in the AMC manager 204 also monitors and processes data from the wireless device 102 that indicates when a hand-over from base station 202 and another base station is required. Further, the controller also processes messages to and from the WAM server 206 via the router 208.

The WAM server 206 may configure, control and status the WAM network 106. The WAM server 206 may be integrated with the AMC manager 204 or a stand-alone server as shown in FIG. 2. Examples of server hardware manufactures include SUN MICROSYSTEMS, HP, DELL COMPUTER, and COMPAQ COMPUTER and may have UNIX, WINDOWS (NT, XP), or LINUX operating system. A network operator may interface with the WAM server 206 via a command-line interface running over a protocol such as telnet or more sophisticated graphical user interface. The WAM server 206 also collects accounting/billing information for each subscriber sessions set up by the AMC manager. Subscriber management may also be located on WAM server 206 and manages the database of subscribers that includes an address associated with wireless device 102 that may access the WAM network 106.

The payload carrier access manager 205 is shown as a stand-alone server. In alternate embodiments, the payload carrier access manager 205 may be co-located with the WAM server 206 or may be co-located in the AMC manager 204 (with or without the WAM server 206). The payload carrier access manager 205 identifies the network that may to be used to transfer data to or from the wireless device 102 when the predetermined criterion is met. The selection by the payload carrier access manager 204 results in a carrier access identification being selected and sent to the AMC manager 204.

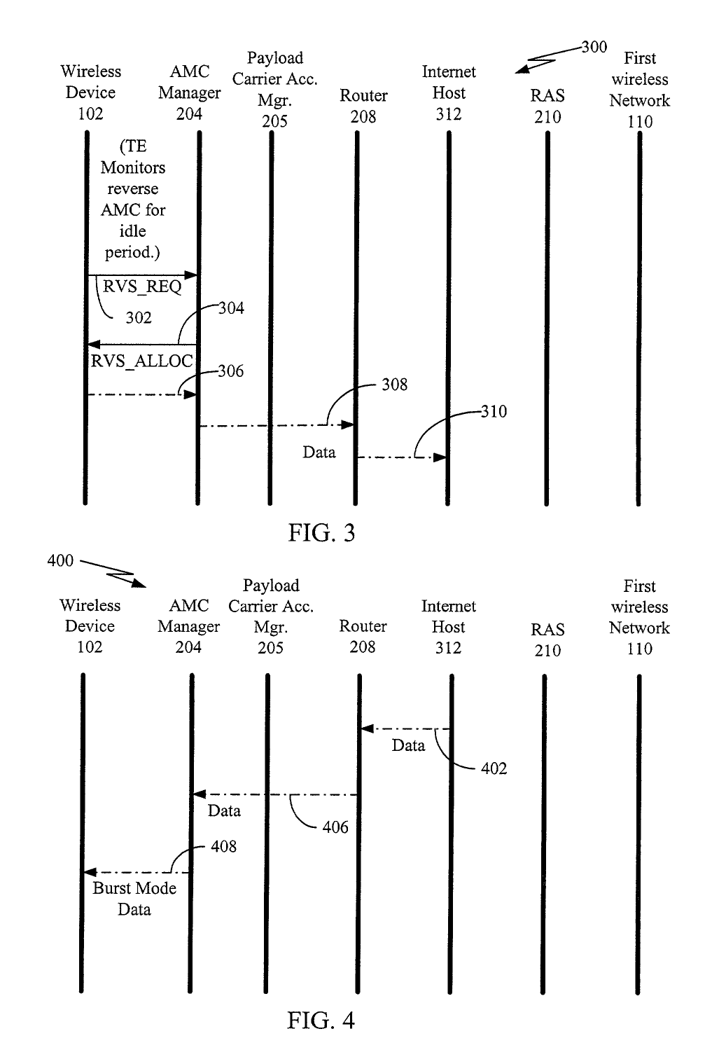

In FIG. 3, a message flow diagram 300 of a wireless device 102 initiating a burst mode data transfer in WAM network 106 of FIG. 2 is shown. A subscriber using the wireless device 102 causes an autonomous data transfer from the wireless device 102 to an Internet host 312 located in the Internet 112. For example, clicking on a web link of a web page displayed on the wireless device 102. When the wireless device 102 is ready to initiate a short data transfer it waits for an idle period on the reverse AMC 104. Upon an idle period being identified, the wireless device 102 sends a RVS_REQ message 302 to the AMC manager 204. The AMC Manager 204 responds to the received RVS_REQ message 302 by allocating bandwidth, for example a time slot, during which the wireless device 102 may be allowed to transfer a burst mode message to the AMC manager 204. The AMC manager 204 then sends a RVS_ALLOC message 304 that includes an allocated bandwidth identifier associated with the allocated time slot to the wireless device 102. Once the time slot is allocated, the wireless device 102 sends data in a short burst message 306 to the AMC manager 204, which then sends the data in a message 308 to the router 208 that routes the data in message 310 to the appropriate Internet host 312.

Turning to FIG. 4, a message flow diagram 400 of an Internet host 312 initiated burst mode data transfer with wireless device 102 in a WAM network 106 of FIG. 2 is shown. The Internet host 312 initiates a transfer of data to the wireless device 102. This may be in response to a previous wireless device-initiated request or other third-party activity such as messaging. The data is sent in a message 402 from the Internet host 312 to the router 208. The router routes the message 406 to the AMC manager 204. The AMC manager 204 transmits a burst mode data message 408 containing the data from the received message 406 and also containing the address associated with wireless device 102 over the appropriate BTS 202 and AMC 104 to wireless device 102.

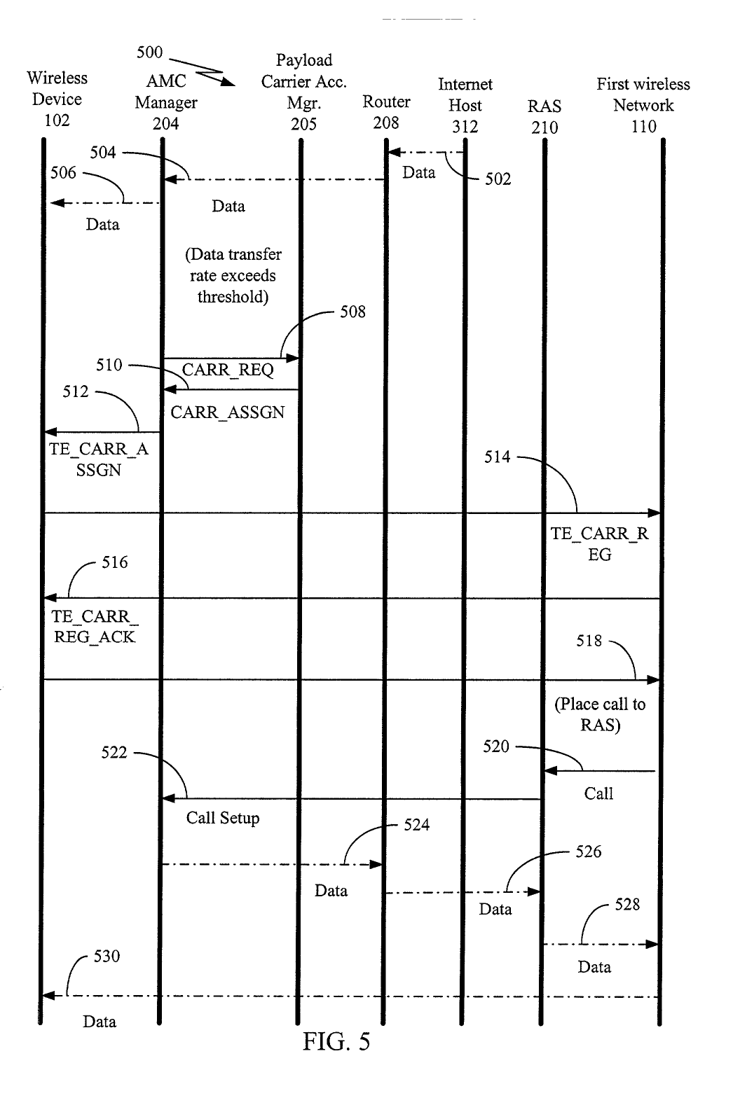

Referring to FIG. 5, a message flow diagram 500 of an AMC manager 204 initiated acquired bandwidth data transfer in WAM network 106 of FIG. 2 is shown. The Internet host 312 sends data 502 to the AMC manager 204 for transmission to the wireless device 102.

The management network maintains a database of the profile of each WAM terminal (user). The database contains parameters that specify the maximum number of payload channels that may be allocated and when payload channels should be allocated or de-allocated for the wireless device 102. For each payload channel allowed, allocation bandwidth utilization threshold and persistence timers are specified. When the device is engaged in a data transfer that exceeds the allocation threshold for the specified duration, the next payload channel is allocated if the device user's profile permits. Similarly, for each payload channel de-allocation bandwidth utilization thresholds and persistence timers are specified. If the current utilization falls below the de-allocation threshold for the specified duration, the last payload channel is de-allocated. Utilization thresholds may be specified in terms of percent occupancy of current bandwidth or data transfer rates (bytes per second).

The AMC manager 204 receives the data 504 and determines that the amount of data or required bandwidth exceeds the AMC threshold. The AMC manager 204 then initiates an acquired bandwidth data transfer session by sending a CARR_REQ message 508 to the payload carrier access manager 205 requesting an optimal access carrier. The subscriber manager identifies the optimal access carrier to provide the payload channel 108 as described above and a CARR_ASSGN message 510 having an access carrier network ID (for the first wireless network 110 in the present example) and the address to be used on that network may be returned from the payload carrier access manager 205 to the AMC manager 204.

The WAM manager 204 notifies the wireless access device 102 by sending over the AMC 104 a TE_CARR_ASSN message 512 that also contains the carrier network ID and the address. The wireless device 102 then sends a TE_CARR_REG message 514 to the first wireless network 110 to register in the first wireless network 110. The first wireless network 110 responds to the wireless device 102, with a TE_CARR_REG_ACK message 516 when the wireless device 102 is registered in the first wireless network 110.

The wireless device 110 then initiates the messaging 518 to place a modem call to the RAS 210 in the first wireless network 110 resulting in the assignment of a payload channel 108. The first wireless network 110 then communicates messages 520 to terminate the call at the RAS 210. Once the modem call is established, the RAS 210 notifies the AMC manager 204 with a call setup message 522.

The AMC manager 204 then routes the packets of data received from the router 208, back to the router 208 as packets of data 524. The router 208 then forwards the packets of data 526 to the RAS 210. The RAS 210 then send the data packets 528 to the first wireless network 110. The first wireless network 110 then send the data packets over the payload carrier 108 to the wireless device. The same message flow would have been conducted with the second wireless network 116 replacing the first wireless network 110, if the payload carrier access manager 205 had selected the second wireless network 116.

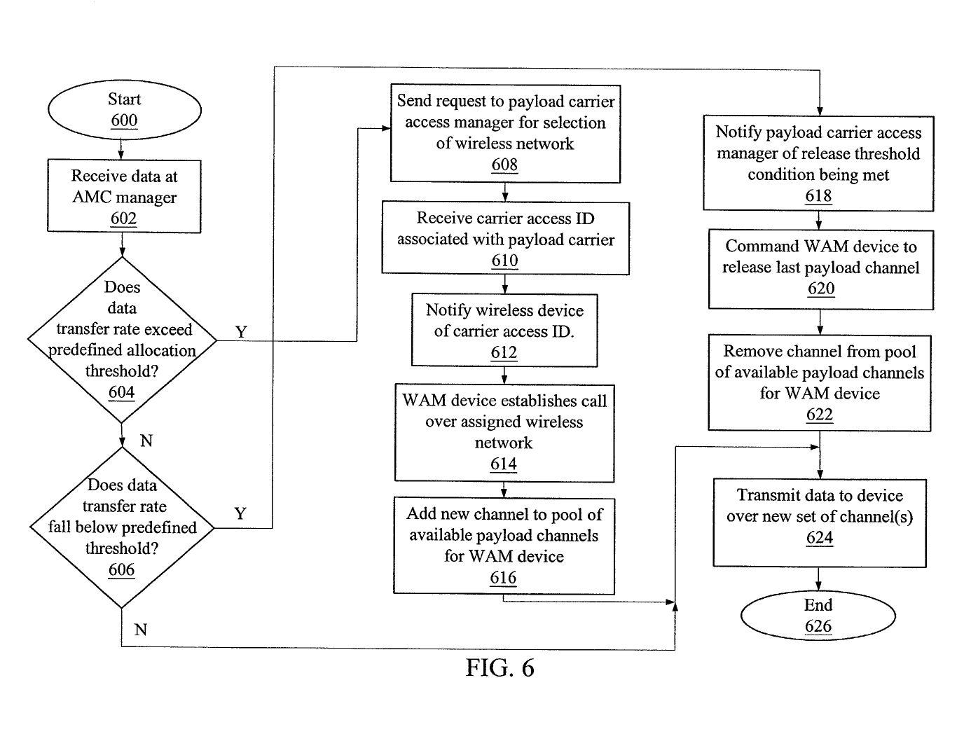

Turning to FIG. 6, a flow diagram of the process of an AMC manager 204 initiating an acquired bandwidth data transfer in WAM network 106 of FIG. 2 is shown. The process starts (600) and data is received by at the AMC manager 204 (602) from the Internet host 312 via the Internet 112. The AMC manager 204 determines if the current data transfer rate between the wireless device 102 and the Internet host 312 meets a predetermined criteria for allocation of another payload channel as described above (604). If these criteria are not satisfied, then the AMC manager 204 determines if the criteria for de-allocation of a payload channel have been met (606). If neither of these conditions are satisfied, the data or plurality of data packets are TDMA encoded and transmitted over the existing channel pool to the wireless device 102 (624). Other types of encoding such as CDMA, CDMA2000, GSM, AMPS, TACS, and other wireless protocols may be used in other embodiments.

If the predetermined criteria for allocation are met, then the AMC manager 204 sends a request to the payload carrier access manager 205 for selection of a wireless network (608). The AMC manager 204 receives a carrier access ID associated with the payload carrier (wireless network) from the payload carrier access manager 205 (610). The AMC manager 204 then notifies the wireless device 102 of the carrier access ID (612) by transmitting the data across the AMC 104. The wireless device 102 establishes a call to the RAS 210 of the WAM network 106 over the assigned fixed wireless network 110 (614). When the AMC manager 204 is notified of the establishment of the new payload channel, The AMC manager 204 adds this channel to the existing pool of channels already established between the wireless device 102 and the WAM network 106. If this were the first payload channel to be allocated, the existing pool of channels would consist only of the AMC channel 104. In an alternate embodiment, at least one channel will exist in the pool of channels even if unassigned to ensuring a channel is available for an emergency situation.

If the predetermined criteria for de-allocation are met, the AMC manager 204 notifies the payload carrier access manager 205 that the condition has been met (618). The AMC manager 204 then commands the wireless device 102 to release the last payload channel (620). The AMC manager then removes the de-allocated channel from the pool of channels available to the wireless device (622),

Data between the wireless device 102 and the Internet host 312 is now transmitted over the new pool of channels. The procedure may be continuous, but for illustration of the process, processing ends at step (626).

### Broadcast Messaging

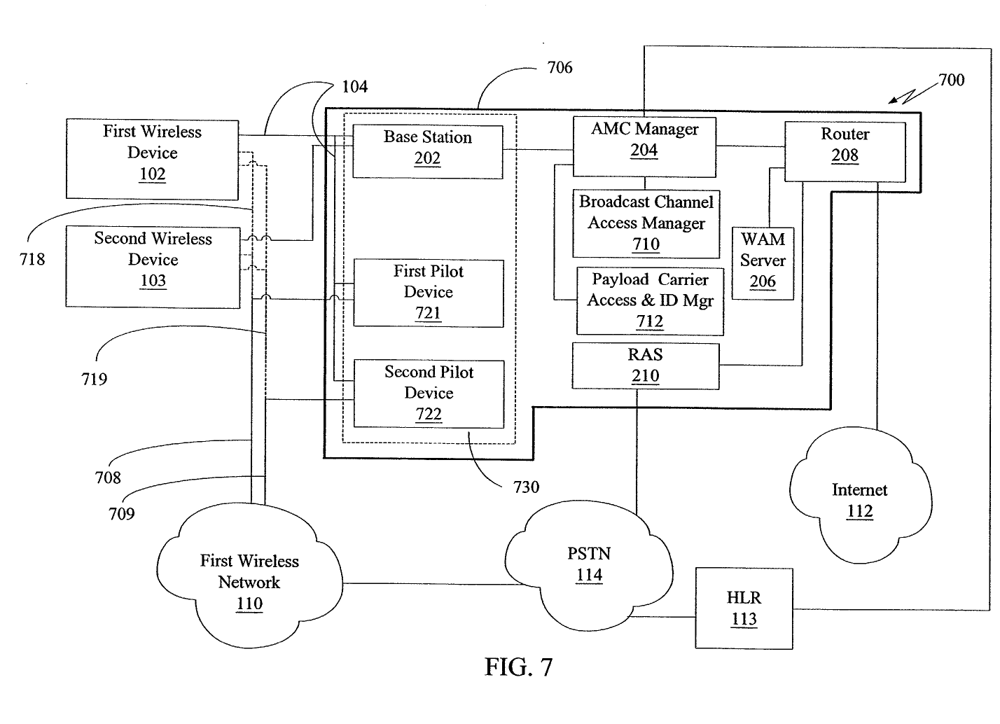

In FIG. 7, a block diagram of WAM network 706 utilizing the broadcast feature is shown. The first wireless device 102 and the second wireless device 103 are communicating with WAM network 706 and the first wireless network 110. The WAM network 706 has at least one base station 202 that may have a transceiver to enable communication over the AMC 104. The WAM network 706 may also contain a first pilot device 721 and a second pilot 722. These pilot devices 721 and 722 communicate with the first wireless network 110 over payload channels. The first pilot device 721 may communicate with the first wireless network 110 over payload channel 708 and the second pilot device 722 may communicate with the first wireless network 110 over payload channel 709.

Every base station in a WAM network, such as 706, may contain one or more pilot devices. These pilot devices communicate with an associated base station. The first and second pilot devices 721 and 722 communicate with base station 202 within a single region sector 730 via AMC channel 104. The AMC channel 104 is under the control of the AMC manager 204. Further, the AMC manager 204 may also be in communication with a broadcast channel access manager 710.

Wireless devices may be instructed via instructions received over the AMC channel 104 to listen to specific payload channels that are assigned to the pilot devices 721 and 722 by the wireless network 110. For example, a data packet intended for the first wireless device 102 may be transmitted to the first wireless network 110 over the payload channel 708 that has been established with the first pilot device 721. The format of the data packet may contain an address header or other identifier indicating that the data packet is intended for the first wireless device 102.

Prior to the data transfer, the first wireless device 102 is instructed by the AMC manager 204 and the broadcast channel access manager 710 to monitor the payload channel 708. When the data packet is transmitted to the first pilot device 721 over payload channel 708 in the first wireless network 110, the first wireless device 102 receives the packet by monitoring the payload channel 708 and decoding or otherwise identifying its address in the packet header of the data packet. In FIG. 7, the payload channel 708 between the first wireless network 110 and the first pilot device 721 is designated by a solid line, while the dotted line 718 signifies the portion of the payload channel 708 picked up by the first wireless device when the first wireless device receives instructed to monitor for data packets containing its address or identifier. In an alternate embodiment, the wireless device when receiving data packets may monitor multiple payload channels rather than a single payload channel. In yet another embodiment, the wireless device may monitor multiple payload channels with the same data packet being sent on each of the payload channels. In yet another embodiment, the data packets may be encoded with a unique address that is decoded by a predefined subset of wireless devices or by all wireless devices.

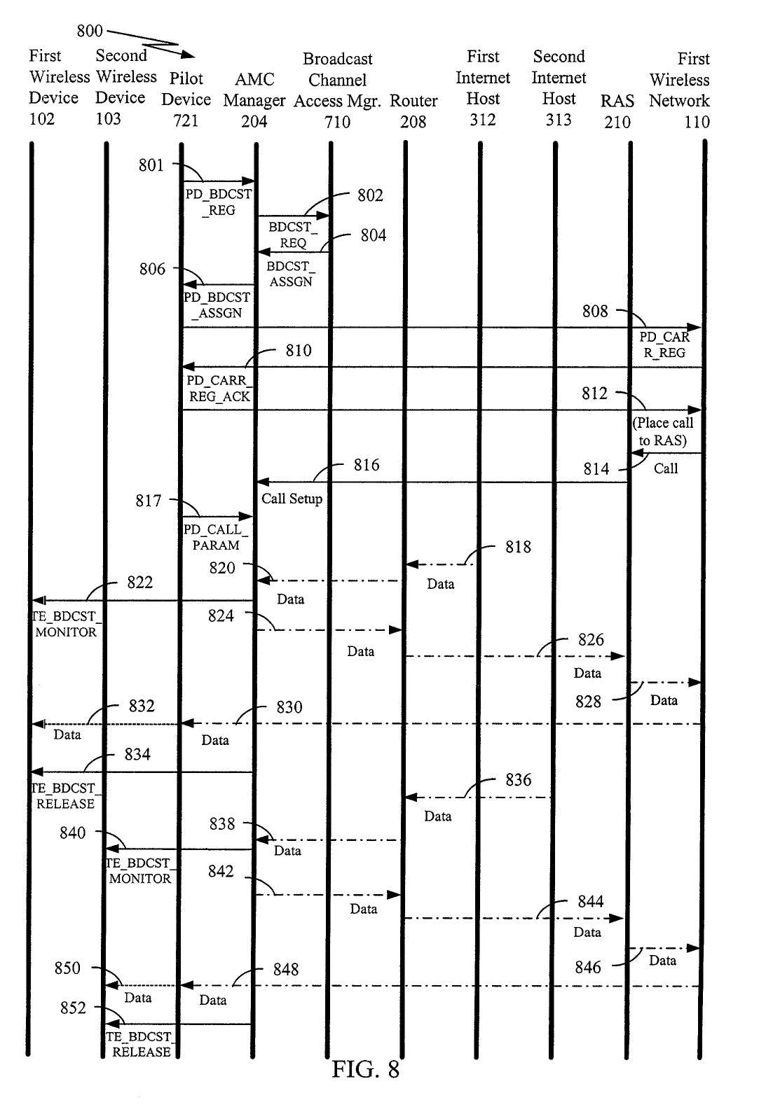

Turning to FIG. 8, which shows a message flow diagram 800 of wireless devices 102 and 103 engaging in a broadcast mode operation within the WAM network 706. When the pilot device 721 initializes, a message PD_BDCST_REG 801 is sent to the AMC manager 204. The AMC manager 204 determines whether the current payload traffic requirements warrant the establishment of a broadcast payload channel to the pilot device 721. If a broadcast payload channel is required, the AMC manager 204 sends a message BDCST_REQ 802 to the broadcast channel access manager 710 that request assignment of a broadcast channel. The broadcast channel access manager 710 responds to the AMC manager 204 with a BDCST_ASSGN message 804 that contains the identities of the pilot device 721 associated with base station 202 and the first wireless network 110 to be used for broadcast traffic. The AMC manager 204 sends a PD_BDCST_ASSGN 806 message to the pilot device 721, which identifies the first wireless network 110 to be used for carrying payload traffic by including a network identifier. In an alternate embodiment, an association table or other type of identification scheme may be used to identify the different wireless networks.

The pilot device 721 registers with the first wireless network 110 by sending a PD_CARR_REG 808 message to the first wireless network 110. The first wireless network 110 acknowledges the request by responding with a PD_CARR_REG_ACK 810 message to pilot device 721. The pilot device proceeds to set up a session or call 812 to the RAS 210 via the first wireless network 110. The session or call 814 terminates at the RAS 210 and the AMC manager 204 is informed of the call setup 816. After the session or call to the first wireless network 110 is completed, the pilot device 721 sends a message PD_CALL_PARAM 817 to the AMC manager 204 to provide it with the details about the call parameters, e.g. channel frequency, slot number, color codes, etc. The AMC manager is now configured to transmit any payload data destined for wireless devices in the range of the base station 202 via the pilot device 721 as follows.

The first Internet host 312 sends data 818 destined for the first wireless device 102 via the router 208, which then forwards the data 820 to the AMC manager 204. When the AMC manager determines that this data transfer requires a payload channel, it signals the first wireless device 102 to begin monitoring the broadcast channel assigned to pilot device 721 by sending TE_BDCST_MONITOR message 822. The AMC manager then forwards the data 824 to the pilot device 721.

The AMC manager 204 sends the data 824 by first encoding the data 824 with the address or identifier of the first wireless device 102 into a data packet. The AMC manager 204 to the router 208 sends the data packet. The router 208 forwards the data 826 to the RAS 210. The RAS 210 sends the data 828 to the first wireless network 110, and the first wireless network 110 sends the data 830 to the pilot device 721. Since the first wireless device 102 has been informed over the AMC 104 to “listen” to the transmission from the first wireless network 110 to the pilot device 721, it receives the data 832 that is encoded with its address or identifier.

After all the data intended for the first wireless device 102 has been transmitted, the AMC manager 204 sends the message TE_BDCST_RELEASE 834 to the first wireless device 102 indicating the termination of the session with the pilot device 721. In alternate embodiments, the termination of the session may occur after the expiration of a timer or detection of an end of file (EOF) indicator in a message. In subsequent payload transfers to the first wireless device 102, other pilot devices in the WAM network 706 may be used.

If a second Internet host 313 sends data 836 to the router 208 intended for the second wireless device 103, a similar message sequence follows. The AMC manager 204 then accepts the data packets 838 from the router 208. In this case, the AMC manager 204 instructs the second wireless device 103 to monitor the payload channel 708 assigned to the first pilot device 721 using TE_BDCST_MONITOR message 840. The AMC manager 204 then encodes the data packets 838 with the address or identifier of the second wireless device 103 and forwards this encoded data 842 to the router 208. The router, in turn, forwards the data 844 to the RAS 210, which forwards the data 846 on to the first wireless network 110. The first wireless network 110 transmits the data 848 over the air to the pilot device 721 over the payload channel 708. The second wireless device 103 monitors the payload channel 708 based on the earlier command from the AMC manager 204 sent via the AMC 104. The second wireless device 103 accepts those packets 850 encoded with its associated address or identifier. This selective reception of packets is indicated by the connection 718 between the first wireless network 110 and the second wireless device 103.

The data transfers from the two hosts such as Internet protocol host or packet data host may overlap, resulting in the AMC manager 204 sending interleaved data packets 824 and 842 encoded respectively with the addresses of the first wireless device 102 and the second wireless device 103 over the payload channel 708 to the pilot device 721. Furthermore, the base station 202 may employ multiple pilot devices of different technology, such as GSM, CDMA, TDMA, 3G, or similar cellular or wireless data network technology. The number of pilot devices may depend on the peak traffic load expected in the sector 730. The technologies of the pilot devices may depend on the technologies of the wireless networks serving the area covered by the sector 730.

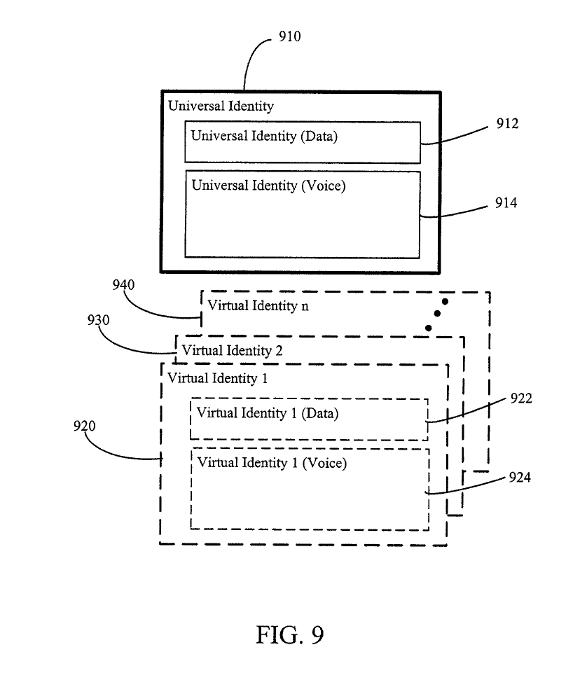

In FIG. 9, a block diagram of the organization of universal and virtual (or “soft”) identities in a wireless device 102 is shown. Each wireless device contains a universal identity 910 that consists of a universal identity for data communication 912 and a universal identity for voice communication 914. The universal identity for data 912 may be a network address, an IP address or any combination of the aforementioned that is necessary for the device to be addressed within public or private, wire-line or wireless data networks. The universal identity for voice communication 914 may be of the form of a device identity, a telephone number, a network identity or any combination of the aforementioned that is necessary for the wireless device to be addressed within public or private, wire-line or wireless networks. The universal identity 910 may be permanently assigned to the wireless device at the time of manufacture or may be assigned by the operator of the WAM network 706 when the wireless device 102 is put into service on the WAM network 706. The universal identity for voice communication 914 contains the “phone number” by which the wireless device can be reached by other users from the PSTN 114.

The wireless device 102 may also possess one or more virtual identities. FIG. 9 shows a multiplicity of such virtual identities 920, 930 and 940. The first virtual identity 920 contains a virtual identity for data 922 and a virtual identity for voice 924. Initially, these virtual identities are blank until the AMC manager 204 assigns them values. In an alternate embodiment, the virtual identities may be set to a default or null value.

The first virtual identity 920 is assigned values for its data component 922 and voice component 924 dynamically by the AMC manager 204. The wireless device 102 uses the first virtual identity 920 to access wireless networks, Internet hosts or other network entities. The wireless device 102 for the duration of a data connection or voice call maintains the first virtual identity 920. After the duration of the data connection or voice call, the wireless device 102 “returns” the assigned values for the first virtual identity 920 to the AMC manager 204. The wireless terminal 204 can then no longer use these values for the virtual identity 920. The AMC manager 204 may then reassign the same values for the virtual identity to another wireless device. Henceforth, the term “virtual identities” will be used synonymously with virtual identity values.

The WAM network 204 may maintain several groups of virtual identities, one for each of the wireless networks that it interfaces with.

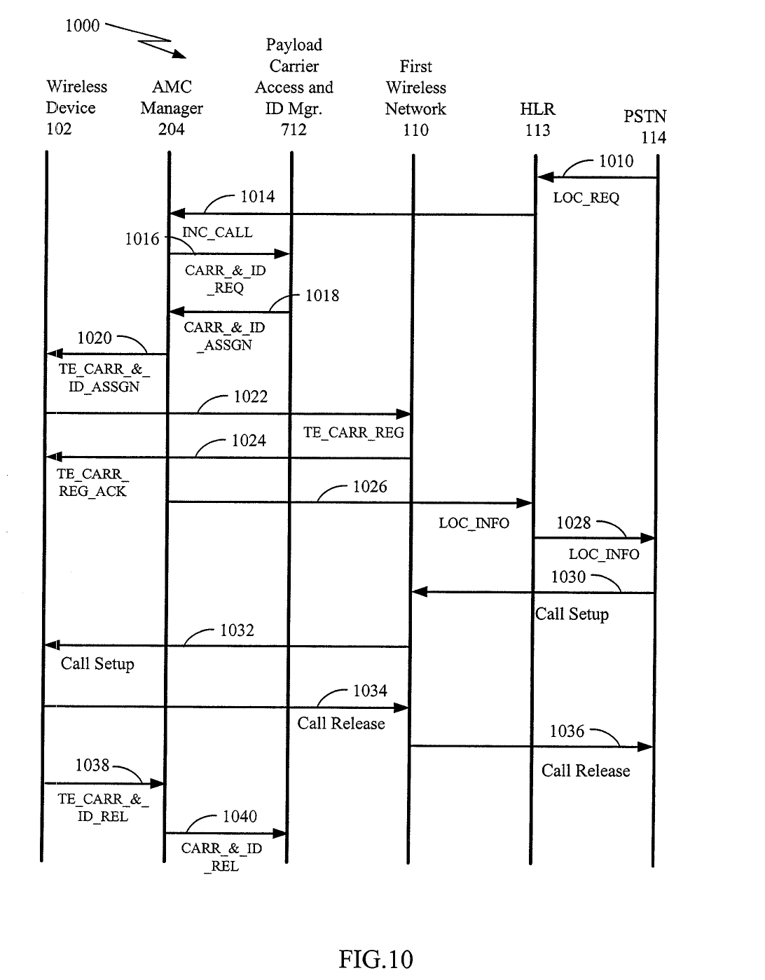

FIG. 10 shows a message flow diagram 1000 of a voice call originating from the PSTN 114 and terminating at the wireless device 102 where the wireless device 102 is assigned a virtual identity for the duration of the call by the WAM network 706. When the call from the PSTN is made to the wireless device 102, the caller dials the phone number contained in the universal identity for voice communication 914 with the wireless device 102. The PSTN attempts to locate the wireless device 102 by sending out a LOC_REQ message 1010. The LOC_REQ message 1010 is routed to the WAM network HLR 113 because it contains a phone number belonging to the WAM network 706. The HLR 113 informs the AMC manager 204 that there is an incoming call for the wireless device 102 by sending it a message INC_CALL 1014. The AMC manager 204 requests virtual identity 920 from the payload carrier access and ID manager 712 by sending it the CARR_&_ID_REQ message 1016. The payload carrier access and ID manager 712 responds to the AMC manager 204 with virtual identity 920 in message CARR_&_ID_ASSGN 1018. The AMC manager 204 sends the virtual identity 920 to the wireless device 102 in the message TE_CARR_&_ID_ASSGN 1020. The wireless device 102 then register with the first wireless network 110 by sending message TE_CARR_REG 1022. The first wireless network 110 acknowledges the registration by sending message TE_CARR_REG_ACK 1024 back to the wireless device 102. The AMC manager 204 responds to the HLR 113 with location information on the wireless device 102 by sending message LOC_INFO 1028. This message will provide the HLR 113 with the virtual identity 920 assigned to the wireless device 102 for this call. The HLR 113 forwards the virtual identity 920 to the originating switch in the PSTN 114. From the virtual identity 920, the originating switch in the PSTN 114 can determine the first wireless network 110 on which the wireless device 102 has registered using the virtual identity 920. The originating switch in the PSTN 114 sends a call setup message 1030 to the first wireless network 110 that is then relayed 1032 to the wireless device 102.

When the voice call is completed and the wireless device 102 releases the call, it send a call release message 1034 to the first wireless network 110 which relays the message 1036 to the PSTN 114. The wireless device 102 then returns the virtual identity 920 to the AMC manager 204 by sending it a message TE_CARR_&_ID_RET 1038. The AMC manager 204 sends a CARR_&_ID_RET message 1040 to the payload carrier access and ID manager 712 informing it that the virtual identity 920 can now be reassigned to another wireless device.

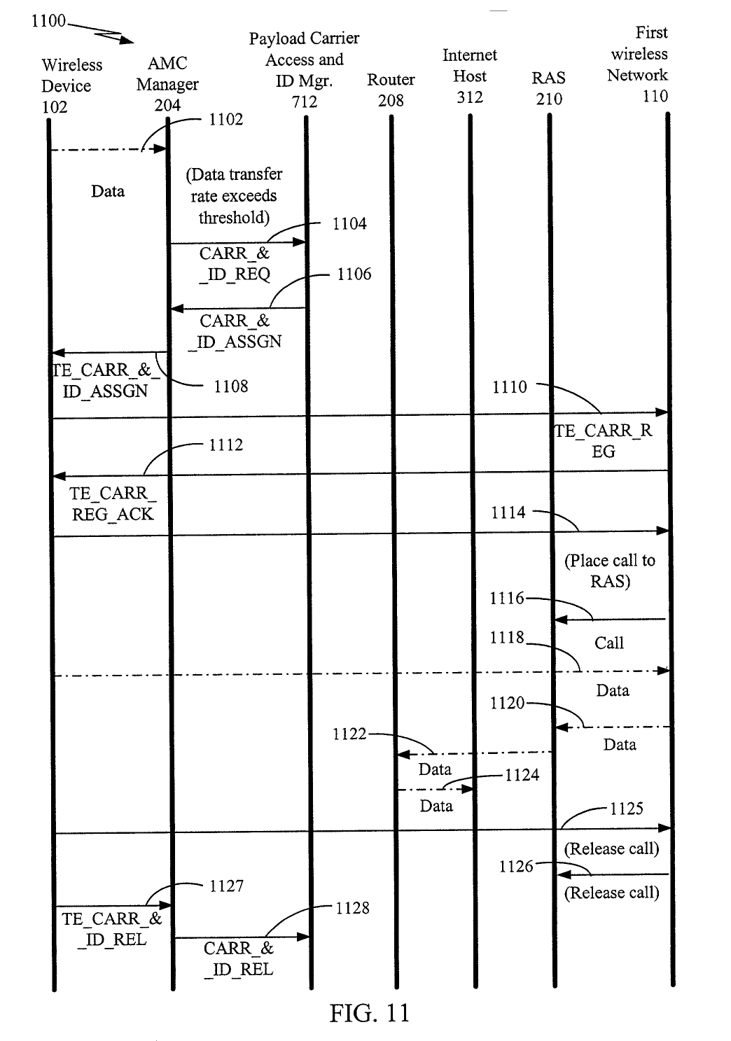

In FIG. 11, a message flow diagram 1100 of a wireless device 102 being assigned a payload channel using a virtual identity for data communication on the first wireless network 110 by WAM network 706 is shown. The WAM network 706 maintains a pool of virtual identities that are assignable device identities associated with each of the wireless networks on which payload channels may be allocated. In an alternative embodiment, the assignable device identities may be derived from a predetermined algorithm or procedure.

When a wireless device 102 transmits broadband data 1102 to the AMC manager 204 intended for an Internet host 312, and the AMC manager 204 determines that the traffic threshold for allocating a payload channel has been exceeded, the AMC manager 204 requests the payload carrier access and identity manager 712 to assign a virtual identity using message CARR_&ID_REQ 1104. The payload carrier access and identity manager 712 returns message CARR_&ID_ASSGN 1106 with the requested information to the AMC manager 204. The AMC manager 204 passes the virtual identity to the wireless device 102 in the message TE_CARR_&_ID_ASSGN 1108. The wireless device 102 now uses this information to register with the first wireless network 110.

Message TE_CARR_REG 1110 is sent from the wireless device 102 to the first wireless network 110. This message contains the virtual identity provided to the wireless device 102 by the AMC manager 204. The first wireless network 110 acknowledges the registration with message TE_CARR_REG_ACK 1112. The wireless device 102 then establishes a call 1114 to the first wireless network 110 and requests to be connected to the RAS 210. The call 1116 is terminated at the RAS 210. The wireless device 102 is then able to sends data 1118 via the first wireless network 110, which is forwarded as data 1120 to the RAS 210. The RAS 210 sends the received data 1120 as data 1122 to the router 208. The router 208 then forwards the data 1124 to the Internet host 312. In an alternate embodiment, the virtual identity may be a plurality of virtual identities that enables the wireless device to make multiple calls on the first wireless network 110 or on multiple wireless networks.

Upon the wireless device 102 completing the data transfer to the Internet host 312, the payload channel 1125 to the first wireless network 110 is released. The first wireless network 110 disconnects the call 1126 from the RAS 210. The wireless device 102 then returns the virtual identity to the WAM network 706 by sending a message TE_CARR_&_ID_REL 1127 to the AMC manager. The AMC manager 204 passes this information in a CARR_&_ID_REL message 1128 to the payload carrier access and identity manager 712. At this point, the virtual identity is returned to the WAM network's pool of virtual identities. The virtual identity is then available to be assigned to other wireless devices requesting access to a payload channel on the first wireless network 110. In an alternate embodiment, the pool of virtual identities is a dynamic pool with the identities being generated by an algorithm. In yet another embodiment, the pool of virtual identities is a fixed size (may be used to control loading) and if exhausted results in denial of a payload channel. In yet other embodiments, the wireless device may pay more to have a parameter that enables it to have a higher priority to the pool of virtual identities when the pool of virtual identities reaches a predetermined threshold, than a wireless device that pays less. In yet other embodiments, virtual identities may be assigned on a priority basis depending on the class of service of the device. In yet other embodiments, the priority of devices may be governed by conditions declared by the WAM network operator, e.g. emergency conditions may prioritize certain devices based on their class of service and the level of emergency condition.

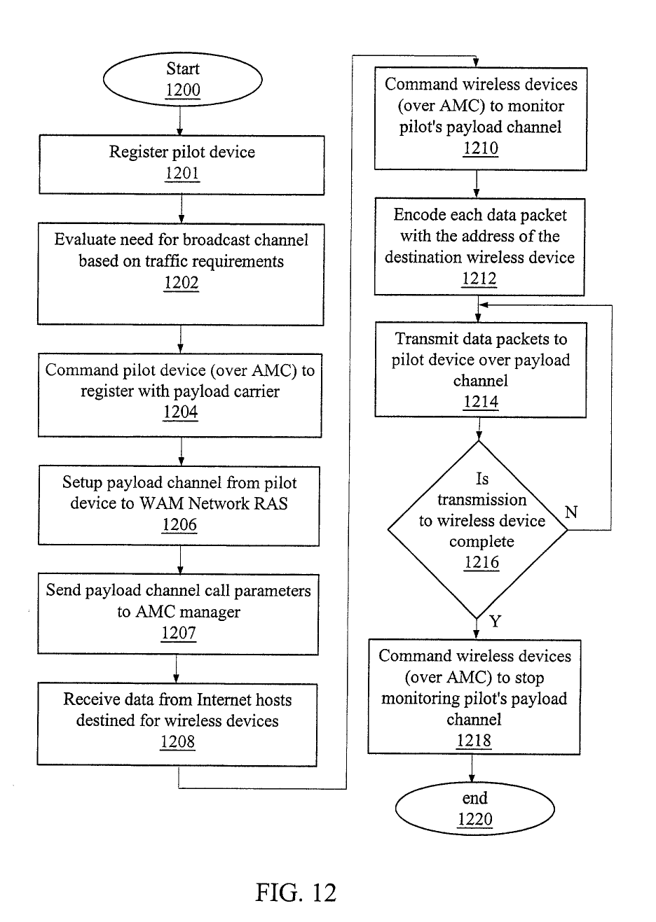

Turning to FIG. 12, a flow diagram of the process of wireless devices 102 and 103 engaging in a broadcast mode operation in WAM network 706 is shown. When a pilot device 721 initializes, it registers (1201) with the AMC manager 204 over the AMC. The AMC manager 204 requests the broadcast channel access manager 710 to determine (1202) if the current traffic requirements in the sector warrant the establishment of a broadcast channel. If so, the pilot device 721 is provided (1204) information about the wireless network it should use to establish a broadcast payload channel. The pilot then establishes (1206) a payload channel between itself and the WAM network over the wireless network 110 and informs the AMC manager 204 about the call parameters associated with the payload channel (1207). Subsequently, when the WAM network receives data (1208) from an Internet host 312 destined for a wireless device 102 in the coverage range of the pilot device 721, the wireless device 102 is sent a command over the AMC (1210) providing it the parameters of the payload channel call and instructing it to monitor the transmission from the base station to the pilot device 721. The WAM network then encodes the data packets destined for the wireless device with an address unique indicator (1212) and transmits them over the payload channel (1214) to the pilot device 721. The wireless device 102 “listens” to all the data transmission from the base station to the pilot device 721 on the payload channel that it was earlier instructed to monitor, decoding the packet headers to look for those packets bearing its own address. Packets with addresses of other wireless devices that may be tuned into the same payload channel are discarded. Once the payload data for the wireless device has completed transmission (1216) and an end of data is detected, the WAM network instructs the wireless device 102 to stop monitoring (1218) the broadcast payload channel. The processing ends at step (1220).

Although FIG. 12 has illustrated a simple data transfer within a single sector, more complex scenarios involving sector-to-sector handoffs (inter-base station and intra-base station) during data transfer are possible utilizing the same method for broadcasting data over payload channels of pilot devices in multiple sectors. In such cases, the WAM network controls handoff processing of the wireless device using the AMC as a control channel. Broadcast operation with multiple pilot devices in the same sector on the same wireless network may also be configured. This allows for greater throughput of data to the wireless device by aggregating the bandwidth of the individual payload channels.

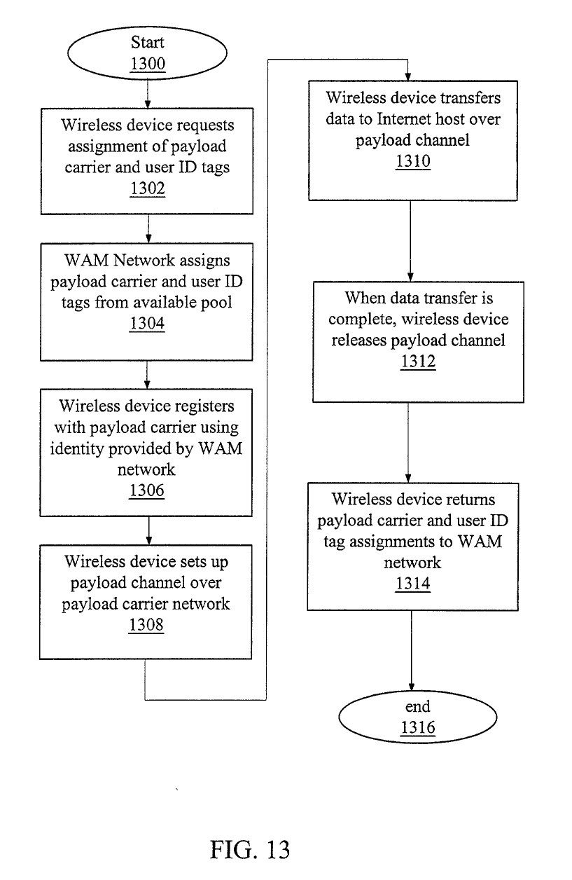

In FIG. 13, an illustration of a flow diagram for a wireless device 102 engaging in a “soft” identity transaction in the WAM network is shown. The process begins (1300) when a wireless device 102 requests assignment of a payload channel (1302). In this case, the device also requests the assignment of virtual identity that will allow access to the assigned payload carrier network. Such virtual identity may consist of the identification numbers and if multiple tags, codes that are contained in the wireless device 102 or possible a SIM card (such as used in the GSM cellular telephone) in a conventional, non-WAM-enabled wireless device. The WAM system maintains a pool of such virtual identities for each wireless network used for providing payload channels in the WAM network's service area. The WAM system assigns one virtual identity to the device from the pool of available virtual identities (1304). Using this virtual identity, the wireless device registers with the assigned wireless network (1306) and sets up a call to the WAM network (1308). The wireless device then uses the payload channel to transfer its data to the intended Internet host (1310). After the transfer is complete, the wireless device releases the payload channel (1312) and returns the virtual identity to the WAM network (1314) so that they may be assigned to other wireless devices in the WAM network. The process terminates at this point (1316).

### WAM Network Robustness

Besides obtaining a channel to place a call or establish a session, another common problem experienced by users during emergencies is the ability to reach another users who is engaged in an existing conversation. Due to the high call volume, the probability of such an occurrence is correspondingly higher. Organizations that use a Priority Access Service (PAS) approach have a command hierarchy with established rules of precedence for establishing calls or sessions.

Barge-In PAS

The ability to communicate “out-of-band” with wireless devices enables a WAM network to implement a “Barge-In” Priority Access Service (BIPAS) that enables users to interrupt or override existing calls or sessions depending on their priority ranking of the person barging into the call. The advantage of the BIPAS approach compared to traditional PAS solutions is that the original call or session connection is not surrendered. This is important during an emergency because congestion will delay or could prevent the establishment of a new call or session. This is true even if a PAS approach were implemented because a number of PAS-enabled users may be competing for limited network resources. The BIPAS approach is also applicable between WAM networks and other wireless and wire-line networks using AIN services.

The BIPAS feature is implemented in the WAM network by having the WAM network HLR connected to a common switch at an Emergency Management Center (EMC). The connection may be over dedicated links, or preferably being collocated with the common switch at the EMC. The switching facility is invoked in the case of a disaster or emergency and results in calls or sessions being routed through a common switching matrix. Under such emergency conditions, the BMM routes voice calls from originating devices to the EMC switch that then forwards the call or session to the destination party. Correspondingly, calls terminating at a device in the WAM network are directed to the EMC switch by the WAM HLR and are then forwarded on to the device in the WAM network. In an alternate embodiment, a group of switches either co-located or networked together may operate as the EMC and coordinate calls or sessions through the group of switches.

Once an emergency has occurred, BIPAS is activated in the WAM network and controlled at the switch based on information passed on by each WAM node and obtained from each user profile associated with an active call or session. Further, information may also be directly received from the active wireless devices that are present in each of the WAM nodes. These BIPAS parameters may include barge-in rank, privileges, identification of calling and called parties on the original calls or sessions. The BIPAS may be activated by the network upon detection of an overload condition, or upon human intervention, such as a command being entered at a operations and maintenance center terminal. Table 1 gives an example of BIPAS barge-in ranks applied to various military personal call scenarios.

TABLE 1
BIPAS Scenarios

| Existing Call | | | |
|---|---|---|---|
| Calling Party | Called Party | New Caller | BIPAS Action |
| Captain | Major | Colonel calling Major | Barge-In |
| Major | Colonel | Captain calling Major | Deny |
| Captain | Colonel | Major calling Colonel | Barge-In |
| Colonel | Captain | Major calling Colonel | Notify |
| Colonel | Captain | Major calling Captain | Deny |

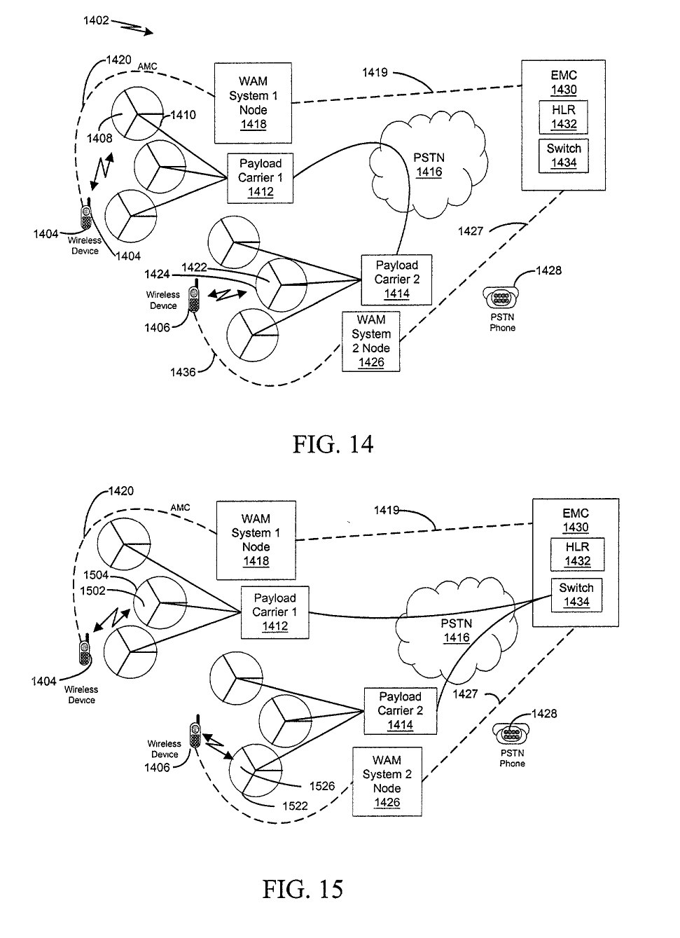

FIGS. 14 through 17 show the sequence of events in the case of a successful BIPAS barge-in. In FIG. 14, a diagram of a WAM network 1402 with two wireless devices 1404 and 1406 in communication prior to an emergency condition. The wireless device 1404 is communicating with a first sector 1408 of a payload cell 1410 in a payload network, for example a CDMA cellular network. The payload cell 1410 is in communication with payload carrier one or payload controller 1412, such as a cellular switch. Payload carrier one 1412 communicates with a second payload carrier, payload carrier two 1414, via the public switch telephone network (PSTN) 1416. In an alternate embodiment, a private communication network may provide the connection between payload carriers. The wireless device 1404 also communicates with the WAM system one node 1418 via AMC 1420. Wireless device 1406 is in communication with a sector 1422 of payload cell 1424. Payload cell 1424 is in communication with payload carrier two 1414 and is also in communication with payload carrier one 1412 via PSTN 1416. Wireless device 1406 is also in communication with WAM system two node 1426 via AMC 1436.

Other terminals such as PSTN telephone 1428 may be available for connection to the PSTN 1416. Examples of other types of terminals include, Internet device (video, audio, data, or any combination of audio, video and data) such as a personal computer, set top box, handheld device connected to a modem, telephone, telephonic devices or cellular telephone to name but a few. FIG. 14 also depicts an EMC 1420 with a home location register (HLR) 1432 collocated with switch 1434. The EMC 1420 also may have connections such as 1419 and 1427 with WAM system one node 1416 and WAM system two node 1426 respectively. Not shown in FIG. 14 are the connections that may exist from the WAM system nodes 1426, other telephone 1428, HLR 1432, and switch 1434 to the PSTN 1416.

An Emergency Management Center (EMC) 1430 has not been activated (i.e. not in communication with the WAM network 1402) nor has telephone 1428 attempted to establish a call or session to either wireless device 1404 or 1406.

Turning to FIG. 15, a diagram of the WAM network 1402 of FIG. 14 after the onset of an emergency condition and the activation of the EMC 1430 is shown. Upon the EMC 1430 being activated, subsequent connections between payload carrier one 1412 that connect wireless device 1404 and payload carrier two 1414 that connect wireless device 1406 are routed via the PSTN 1416 through the switch 1434 at the EMC 1430. This is done by the EMC 1430 informing all WAM system nodes such as WAM system one node 1418 and WAM system two node 1426 to route all calls via the EMC 1430. The WAM system nodes 1418 and 1426 and the EMC 1430 communicate over data links 1419 and 1427 respectively.

Wireless device 1404 is shown to have set up a new call after activation of the emergency condition on sector 1502 of cell 1504. The call is switched through the PSTN 1416 to the EMC switch 1434 and then through to payload carrier two 1414 where it is terminated at wireless device 1406 on sector 1526 of cell 1522. Cell 1504 is similarly in communication with payload carrier one 1412 as cell 1410. Wireless device 1404 is in communication with WAM system one node 1418 via AMC 1420.

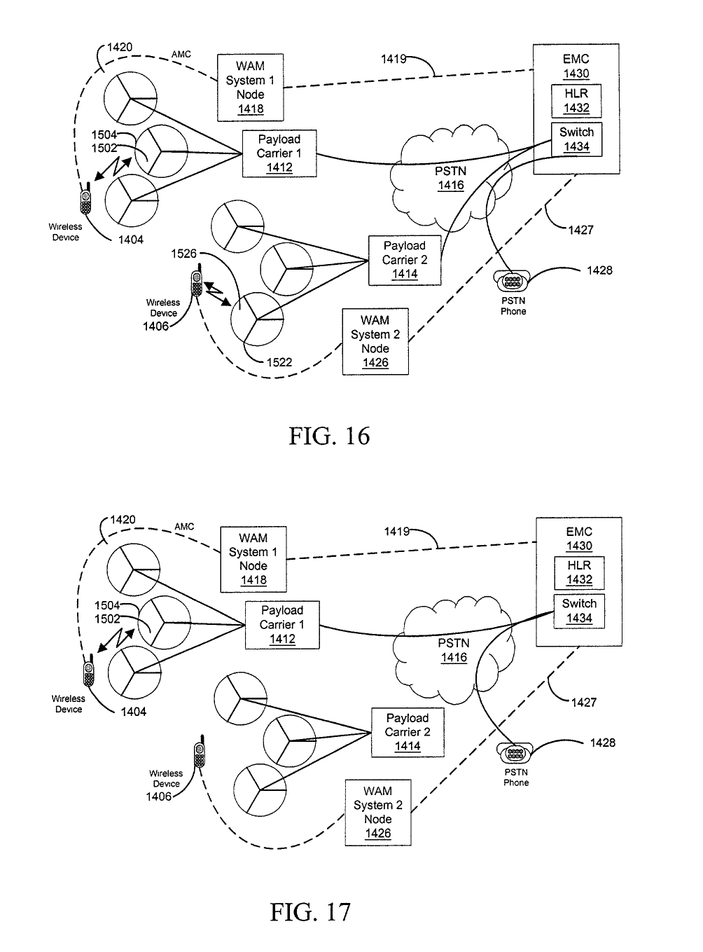

In FIG. 16, a diagram of the WAM network 1402 of FIG. 14 with an incoming call or session from a priority telephone 1428 to a busy wireless device 1404 is shown. The telephone 1428 has priority due to its rank that was previously entered in a table or data structure at the HLR 1432 at EMC 1430. In an alternate embodiment, the user of telephone 1428 or other terminal device may enter a priority code that establishes a rank in the table or data structure located at the EMC 1430 either in the HLR 1432 or switch 1434. In yet another embodiment, the rank my exist on a card that is inserted in the terminal device that establishes the rank of the terminal device during call setup without the use of a data structure or database located at the EMC 1430. The telephone 1428 establishes a connection with switch 1434 at the EMC 1430 via the PSTN.

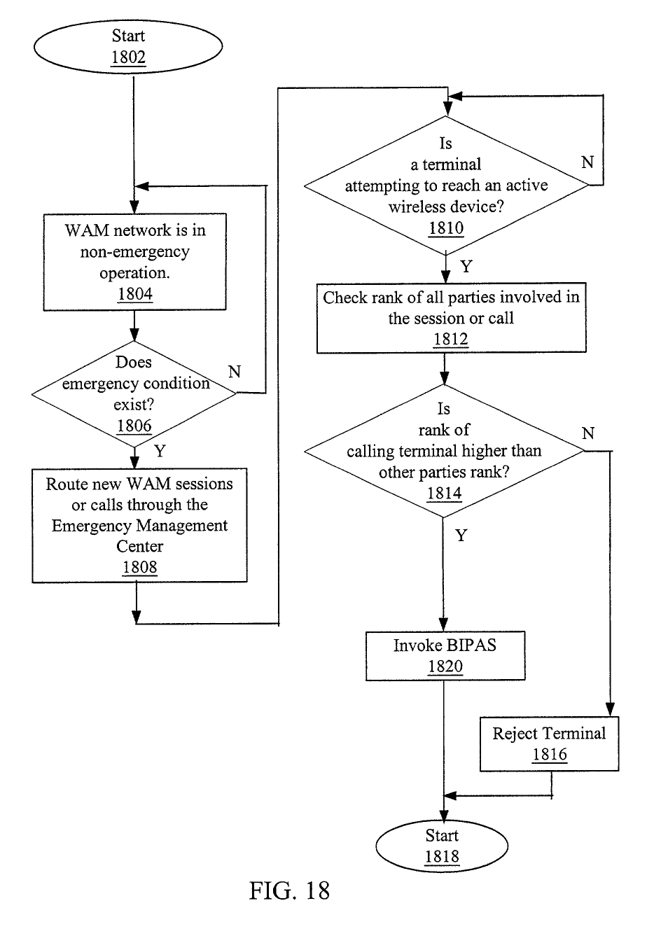

Referring to FIG. 18, a diagram of the WAM network 1402 of FIG. 14 with a BIPAS call or session performed by the EMC 1440 is shown. The switch 1434 at the EMC 1440 receives a message, commonly called a call setup message, from the telephone 1428 indicating that it is attempting to setup a call or session to wireless device 1404. The switch 1434 at the EMC 1430 decodes the message and checks the HLR 1432 to determine the priority assigned to the telephone 1428. The rank verification may be based on a lookup table that is referenced by the called or session party id that is commonly referred to as the calling parties identification. The terminal telephone is located in the lookup table. The device being called is also located in the HLR 1432 and its priority is determined. The priority of the telephone 1428 is compared to the priority of wireless device 1404. If the priority or rank of device 1404 is less than the priority or rank of telephone 1428, then a connection is made via payload carrier one to wireless device 1404 at switch 1434 without the connection to wireless device 1404 from the switch 1434 being released. In another embodiment, the rank of wireless device 1406 is determined and if less than the rank of telephone 1428, wireless device 1406 is released and telephone 1428 is connected with wireless device 1404. In yet another embodiment, both the priority or rank of wireless device 1404 and wireless device 1406 (devices currently in communication) are determined and compared with the priority of telephone 1428, and if the priority of telephone 1428 is greater than both wireless device 1404 and wireless device 1406 wireless device 1406 is dropped and a connection is made between telephone 1428 and 1404. If a barge-in is not to occur because of the priority or rank, than the telephone 1428 receives a busy or other signal indicating connection cannot be completed. In an alternate embodiment, a default value in the lookup table or other barge-in data structure may be used for originating devices that do not have a rank assigned.

The WAM network is not immune from damage during disasters. However, due to the limited infrastructure required to implement the WAM system's “thin” overlay, its network elements are more easily restored in disaster situations than conventional wireless network cell sites and switches. In an alternate embodiment, BIPAS solutions between a WAM network and other wireless and wired networks are also possible using AIN services.

Some of the WAM base stations will be collocated with those of existing wireless operators for convenience. However, a percentage of them may be isolated to provide the necessary coverage in case of a local failure. In an alternate embodiment, an overlay-underlay concept may also be employed (either separately or with isolated WAM base stations) to provide umbrellas of AMC channels for backup and/or overflow.

The recovery of a lost WAM base station can be accomplished in less time than a traditional cellular base station. This is because a WAM base station supports a single narrowband control channel and the physical facilities (space, environmental, power, backhaul, etc.) required for a WAM base station are a fraction of those needed for a conventional wireless base station. Conventional base stations require significant sources of power (100's of amps of DC power) and backhaul transport (multiple T1's) making the restoration of these facilities difficult and time consuming. On the other hand, power from a small portable generator could run a WAM base station and a dial-up 56 kbps circuit or short haul microwave hop could provide the narrowband link from WAM base station to its node. A WAM base station can be easily and rapidly transported to a new site without the need for heavy transportation vehicles or special rigging equipment. Thus, compared to the traditional “cell-on-wheels”, a light truck with the complete equipment and supporting infrastructure for an emergency response/replacement WAM cell can be maintained in a deployment-ready state.

In FIG. 18, a flow diagram of the steps taken when an emergency occurs in the WAM network 1402 of FIG. 14 is shown. The WAM network's initial or starting condition (1802) is in a non-emergency operation mode (1804). If an emergency condition such as a natural or manmade disaster should occur, then the operation mode of the WAM network 1402 is changed to an emergency condition (1860). Otherwise, the WAM network 1402 continues to operate as usual in a non-emergency operation mode (1804).

If an emergency condition does exist (1806), then the active calls or sessions that are routed over the WAM network 1402 to wireless devices such as 1404 and 1406 are routed through an Emergency Management Center (EMC) 1430 (1808). If a terminal device 1442 attempts to establish a session or call (1810) with wireless device 1404, then the rank of all parties involved in the active session or call (1812), including the terminal, telephone 1428. If the rank of the calling terminal device, telephone 1428 is higher than the other parties' rank that is currently in communication with wireless device 1404, then BIPAS is invoked (1820) and the session or call is barged-in on and processing is complete (1818). If the rank of the terminal device, telephone 1428 is less than the other parties, the session or call from the terminal device, telephone 1428 is rejected (1816) and processing is complete (1818).

Fallback to Messaging on AMC Channel

Under catastrophic conditions, when no payload carriers are available to service users, the WAM network can still provide narrowband services for basic messaging applications. Such messaging was described in detail previously.

System Manageability

One of the many features of a WAM-based communications solution is that in an emergency situation, it can place the administration, operation and evolution of the system in the hands of one controlling authority. Other multi-operator PAS solutions lack these advantages because although administrative jurisdiction can be unified within one controlling organization, the implementation and operational responsibility will lie with each individual wireless network operator. Significant coordination between these organizations is required to assure smooth and seamless operations.

The WAM solution, on the other hand, provides a disassociated and independent mechanism that requires no customization by the operators.

### Machine-Readable Signal-Bearing Medium

It is appreciated by those skilled in the art that the process shown in FIGS. 7 and 8 may selectively be implemented in hardware, software, or a combination of hardware and software. An embodiment of the process steps employs at least one machine-readable signal-bearing medium. Examples of machine-readable signal bearing mediums include computer-readable mediums such as a magnetic storage medium (i.e. floppy disks, or optical storage such as compact disk (CD) or digital video disk (DVD)), a biological storage medium, or an atomic storage medium, a discrete logic circuit(s) having logic gates for implementing logic functions upon data signals, an application specific integrated circuit having appropriate logic gates, a programmable gate array(s) (PGA), a field programmable gate array (FPGA), a random access memory device (RAM), read only memory device (ROM), electronic programmable random access memory (EPROM), or equivalent. Note that the computer-readable medium could even be paper or another suitable medium, upon which the computer instruction is printed, as the program can be electronically captured, via for instance optical scanning of the paper or other medium, then compiled, interpreted or otherwise processed in a suitable manner if necessary, and then stored in a computer memory.

Additionally, machine-readable signal bearing medium includes computer-readable signal bearing mediums. Computer-readable signal bearing mediums have a modulated carrier signal transmitted over one or more wire based, wireless or fiber optic networks or within a system. For example, one or more wire based, wireless or fiber optic network, such as the telephone network, a local area network, the Internet, or a wireless network having a component of a computer-readable signal residing or passing through the network. The computer readable signal is a representation of one or more machine instructions written in or implemented with any number of programming languages.

Furthermore, the multiple process steps implemented with a programming language, which comprises an ordered listing of executable instructions for implementing logical functions, can be embodied in any machine-readable signal bearing medium for use by or in connection with an instruction execution system, apparatus, or device, such as a computer-based system, controller-containing system having a processor, microprocessor, digital signal processor, discrete logic circuit functioning as a controller, or other system that can fetch the instructions from the instruction execution system, apparatus, or device and execute the instructions.

While various embodiments of the application have been described, it will be apparent to those of ordinary skill in the art that many more embodiments and implementations are possible that are within the scope of this invention. Accordingly, the invention is not to be restricted except in light of the attached claims and their equivalents.

We claim:

1. A wireless access management system comprising:
a management network having an access management channel that sends a first data packet with a payload channel identifier to a first wireless device;
a first wireless network that is able to establish a payload channel between the first wireless network and a first pilot device controlled by the management network; and
the management network directing a plurality of packets of data over the payload channel to the first pilot device with a subset of packets containing an identifier that is associated with the first wireless device.

2. The wireless access management system of claim 1, wherein the identifier is a universal identity.

3. The wireless access management system of claim 2, wherein the universal identity has a data universal identity and a voice universal identity.

4. The wireless access management system of claim 1, including:
a virtual identity associated with the first wireless network assigned to the wireless device by the management network; and
another payload channel established between the first wireless device and the first wireless network using the virtual identity assigned to the wireless device.

5. The wireless access management system of claim 4, wherein the management network selects the virtual identity associated with the first wireless network from at least two wireless networks that include the first wireless network, with each of the wireless networks associated with a plurality of virtual identities and one of the plurality of virtual identities contains the virtual identity.

6. The wireless access management system of claim 4, wherein the other payload channel carries voice encoded data.

7. The wireless access management system of claim 1, further comprising:
another payload channel between the first wireless network and a second pilot device that is controlled by the management access network in response to detection by the wireless access management of predetermined bandwidth condition being met.

8. The wireless access management system of claim 7, wherein the predetermined bandwidth condition is based on a usage history of the first wireless device.

9. The wireless access management system of claim 4, further comprising:
a priority associated with the first wireless device;
an emergency center through which a communication channel controlled by the management network couples the other payload channel used by the first wireless device and another communication device having another priority; and
an originating device having an originating priority that is greater than the other priority and displaces the other communication device on the communication channel that includes the other payload channel.

10. The wireless access management system of claim 9, wherein the communication channel is routed through the emergency center upon detection of an emergency condition.

11. The wireless access management system of claim 10, wherein the emergency condition activated manually.

12. The wireless access management system of claim 9, wherein the originating device is a PSTN phone.

13. The wireless access management system of claim 9, wherein the originating device is another wireless device

14. A wireless device, comprising:
a receiver with a unique identifier that receives via a control channel a message containing a plurality of management data originating from a management network; and
a controller that processes the message and configures the receiver in response to the plurality of management data to monitor a payload channel established in another network for messages that contain the unique identifier.

15. The wireless device of claim 14, wherein the unique identifier is a universal identity associated with the wireless device.

16. A wireless device, comprising:
a receiver with a unique identifier that receives via a control channel a message containing a virtual identity associated with another network from a management network; and
a controller that process the message and configures the wireless device to communicate over the other network using the virtual identity.

17. The wireless device of claim 16, wherein the wireless device is in encoded voice communication with the other network.

18. The wireless device of claim 16, wherein wireless device releases the virtual identity upon completion of communication.

19. A method for wireless access management, comprising:
establishing a payload channel that is associated with a payload identifier between a first wireless network and a first pilot device controlled by a management network;
sending from the management network to a first wireless device via an access management channel a message that contains the payload channel identifier;
directing a plurality of packets of data by the management network over the payload channel with a subset of the plurality of packets of data having an identifier detectable by the first wireless device.

20. The method of wireless access management of claim 19, further comprising encoding the subset of the plurality of packets with a universal identity associated with the first wireless device.

21. The method of wireless access management of claim 20, wherein the universal identity has a data universal identity and a voice universal identity.

22. The method of wireless access management of claim 19, including:
assigning of a virtual identity associated with the first wireless network by the management network to the wireless device; and
establishing another payload channel between the first wireless device and the first wireless network using the virtual identity.

23. The method of wireless access management of claim 22, where assigning further includes:
selecting the virtual identity by the management network from between at least two wireless networks that include the first wireless network, with each of the wireless networks associated with a plurality of virtual identities and one of the plurality of virtual identities contains the virtual identity.

24. The method of wireless access management of claim 19, further comprising:
detecting a predetermined bandwidth condition being met in the management network; and
establishing another payload channel between the first wireless network and a second pilot device that is controlled by the management network in response to the predetermined bandwidth condition being met.

25. The method of wireless access management of claim 24, wherein the other payload channel carries voice encoded data.

26. The method wireless access management of claim 19, further comprising:
establishing another payload channel between the first wireless network and a first wireless device in response to the bandwidth requirements to download a predetermined amount of data determined by the management network.

27. The method wireless access management of claim 19, further comprising:
establishing a priority associated with the first wireless device;
routing a communication channel that includes the other payload channel controlled by the management network through an emergency that couples the first wireless device and another communication device having another priority; and
displacing the other communication device on the communication channel with an originating device having an originating priority that is greater than the other priority associated with the other communication device.

28. The method of wireless access management of claim 27, wherein routing further comprises:
detecting the activation of an emergency condition; and
rerouting the communication channel through the emergency center upon detection of the emergency condition.

29. The method of wireless access management of claim 28, further comprising manual activation of the emergency condition.

30. The method of wireless access management of claim 27, wherein the originating device is a PSTN phone.

31. The method of wireless access management of claim 27, wherein the originating device is another wireless device.

32. A method of wireless communication, comprising:
receiving at a receiver having a unique identifier via a control channel a message containing a plurality of management data originating from a management network;
processing by a controller the message; and
configuring the receiver in response to the plurality of management data to monitor a payload channel established in another network for messages that contain the unique identifier.

33. The method of claim 32, wherein the unique identifier is a universal identity associated with the wireless device.

34. The method of claim 33, wherein the universal identity further comprises a universal data identity and a universal voice identity.

35. A method in a wireless device for establishing communication, comprising:
receiving at a receiver associated with a unique identifier a message that contains a virtual identity associated with another network from the management network;
processing of the message by the controller; and
configuring the wireless device to communicate over the other network using the virtual identity.

36. The method of claim 35, further comprising:
establishing a payload channel between the wireless device and the other network.

37. The method of claim 35, wherein the wireless device is in encoded voice communication with the other network.

38. The method of claim 35, wherein wireless device releases the virtual identity upon completion of communication.

39. A wireless access management system, comprising:
means for establishing a payload channel that is associated with a payload identifier between a first wireless network and a first pilot device controlled by a management network;
means for sending from the management network to a first wireless device via an access management channel a message that contains the payload channel identifier;
means for directing a plurality of packets of data by the management network over the payload channel with a subset of the plurality of packets of data having an identifier detectable by the first wireless device.

40. The wireless access management system of claim 39, further comprising:
encoding the subset of the plurality of packets with a universal identity associated with the first wireless device.

41. The wireless access management system of claim 40, wherein the universal identity has a data universal identity and a voice universal identity.

42. The wireless access management system of claim 39, including:
means for assigning of a virtual identity associated with the first wireless network by the management network to the wireless device; and
means for establishing another payload channel between the first wireless device and the first wireless network using the virtual identity.

43. The wireless access management system of claim 42, where assigning further includes:
means for selecting the virtual identity by the management network from between at least two wireless networks that include the first wireless network, with each of the wireless networks associated with a plurality of virtual identities and one of the plurality of virtual identities contains the virtual identity.

44. The wireless access management system of claim 39, further comprising:
means for detecting a predetermined bandwidth condition being met in the management network; and
means for establishing another payload channel between the first wireless network and a second pilot device that is controlled by the management network in response to the predetermined bandwidth condition being met.

45. The wireless access management system of claim 44, wherein the other payload channel carries voice encoded data.

46. The wireless access management system of claim 39, further comprising:
means for establishing another payload channel between the first wireless network and a first wireless device in response to the bandwidth requirements to download a predetermined amount of data determined by the management network.

47. The wireless access management system of claim 39, further comprising:
means for establishing a priority associated with the first wireless device;
means for routing a communication channel that includes the other payload channel controlled by the management network through an emergency that couples the first wireless device and another communication device having another priority; and
means for displacing the other communication device on the communication channel with an originating device having an originating priority that is greater than the other priority associated with the other communication device.

48. The wireless access management system of claim 47, wherein routing further comprises:
means for detecting the activation of an emergency condition; and
means for rerouting the communication channel through the emergency center upon detection of the emergency condition.

49. The wireless access management system of claim 48, further comprising manual activation of the emergency condition.

50. The wireless access management system of claim 47, wherein the originating device is a PSTN phone.

51. The wireless access management system of claim 47, wherein the originating device is another wireless device.

52. A wireless device, comprising:
means for receiving at a receiver having a unique identifier via a control channel a message containing a plurality of management data originating from a management network;
means for processing by a controller the message; and
means for configuring the receiver in response to the plurality of management data to monitor a payload channel established in another network for messages that contain the unique identifier.

53. The wireless device of claim 52, wherein the unique identifier is a universal identity associated with the wireless device.

54. The wireless device of claim 53, wherein the universal identity further comprises a universal data identity and a universal voice identity.

55. A a wireless device, comprising:
means for receiving at a receiver associated with a unique identifier a message that contains a virtual identity associated with another network from the management network;
means for processing of the message by the controller; and
configuring the wireless device to communicate over the other network using the virtual identity.

56. The wireless device of claim 55, further comprising:
means for establishing a payload channel between the wireless device and the other network.

57. The wireless device of claim 55, wherein the wireless device is in encoded voice communication with the other network.

58. The wireless device of claim 55, wherein wireless device releases the virtual identity upon completion of communication.
